(19) United States
(12) Patent Application Publication
(10) Pub. No.: US 2003/0211865 A1
(43) Pub. Date: Nov. 13, 2003

(54) Controlling mobile telephone by operating information processing apparatus

(75) Inventors: Toshihiro Azami, Kawasaki (JP); Toshihiro Sonoda, Kawasaki (JP); Tomoyoshi Takebayashi, Kawasaki (JP); Yasuo Sato, Kawasaki (JP); Makoto Morioka, Kawasaki (JP); Shinichi Ono, Kawasaki (JP); Midori Fukai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/372,391

(22) Filed: Feb. 25, 2003

(30) Foreign Application Priority Data
May 7, 2002 (JP) 2002-131674

(51) Int. Cl. H04M 1/00

(52) U.S. Cl. 455/557; 455/420

(57) ABSTRACT

An information processing apparatus, which is connectable to a telephone, comprises a processor, a display device, and an input device. The processor displays information which is to be displayed on the telephone, on the display device. In response to an operation of the input device by a user, the processor sends a control signal which is adapted to control the telephone.

### FIELD OF THE INVENTION

The present invention relates to controlling a telephone, and more particularly to controlling a mobile telephone by operating a personal computer.

### BACKGROUND OF INVENTION

Recently, a mobile telephone or an enhanced fixed telephone is configured so that the user can operate keys of the telephone to enter data into the telephone or access a Web page of, for example, “i-mode™” or “L-mode™” provided by NTT Corporation, Japan, via a telephone network. This access to a Web page can be performed only by an accessing operation through such a telephone. In order to operate such a mobile telephone or a fixed telephone, conventionally, the user directly operates keys of the telephone. In such a telephone, however, the number of keys and the size of a display screen of such a telephone are limited. Therefore, operating the keys and checking or viewing on the display screen of such a telephone require much more time and labor than operating a keyboard and a mouse and checking or viewing on a large display screen of an ordinary personal computer (PC).

When a mobile telephone is connected to an information processing apparatus via a cable, it is possible to transfer data, which are previously produced by the information processing apparatus, to the mobile telephone to be stored thereinto, and then use the data in the mobile telephone.

In Japanese Unexamined Patent Publication No. 2001-249739 (A) laid open for public inspection on Sep. 14, 2001, Okamura discloses a method for operating a portable telephone terminal by input through a keyboard of a PC via a serial interface. In this method, a display device of the PC is not used.

The inventors have recognized the need for allowing a user to control a mobile telephone in real time by operating a personal computer.

It is an object of the invention to allow a telephone to be controlled by operating an information processing apparatus.

In accordance with an aspect of the invention, an information processing apparatus, which is connectable to a telephone, comprises a processor, a display device, and an input device. The processor displays information which is to be displayed on the telephone, on the display device. In response to an operation of the input device by a user, the processor sends a control signal which is adapted to control the telephone.

In response to reception of data representative of display information from the telephone, the processor displays the display information on the display device.

In accordance with a further aspect of the invention, a telephone, which is connectable to an information processing apparatus, comprises a processor and a display device. The processor receives a control signal. In response to the received control signal, the processor operates and displays information on said display device. The processor sends back data representative of the information.

In accordance with a still further aspect of the invention, a program (which may be stored on a storage medium) is for use in an information processing apparatus and for controlling a telephone which is connectable to said information processing apparatus. The information processing apparatus comprises a display device and an input device. The program is operable to effect the step of displaying information which is to be displayed on said telephone, on said display device; and the step of sending a control signal which is adapted to control said telephone, in response to an operation of said input device by a user.

In accordance with a still further aspect of the invention, a program (which may be stored on a storage medium) is for use in an information processing apparatus and for controlling a telephone which is connectable to the information processing apparatus. The information processing apparatus comprises a display device. The program being operable to effect the step of receiving a control signal, the step of operating in response to the received control signal, the step of displaying information on said display device, and the step of sending back data representative of the information.

According to the invention, the operation of a telephone can be easily controlled by operating an information processing apparatus.

Throughout the drawings, similar symbols and numerals indicate similar items and functions.

### BRIEF DESCRIPTION OF THE DRAWINGS

FIG. 1 shows the configurations of a personal computer (PC) and a mobile telephone, in accordance with the present invention.

FIG. 2 shows the schematic configurations of functions of the OS's and applications which are related to the invention, and which are implemented on the processor of the PC and on the processor of the mobile telephone.

FIG. 3 is a flow diagram for a preliminary process for allowing the mobile telephone to be controlled by operating the PC, in accordance with the invention.

FIG. 4 shows a flow diagram for the operation for controlling the mobile telephone that is executed by the PC, in accordance with the invention.

FIGS. 5A and 5B show an example of display screens on the PC, and display screens on the mobile telephone which are displayed in accordance with the flow diagram of FIG. 4.

### DESCRIPTION OF THE PREFERRED EMBODIMENT

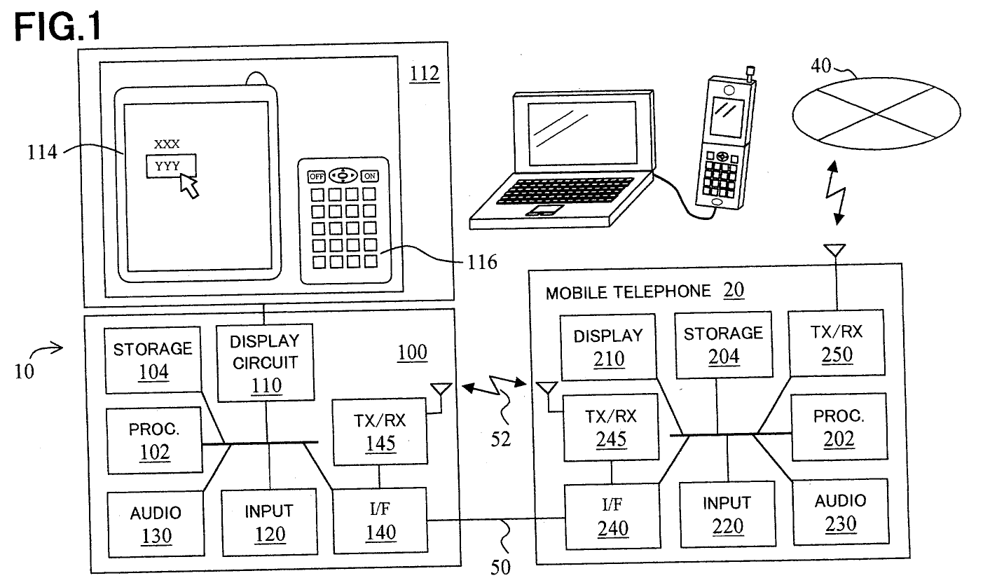

FIG. 1 shows the configurations of a personal computer (PC) 10 and a mobile telephone 20, in accordance with the present invention.

A main unit 100 of the PC 10 includes: a processor 102 having a CPU, a ROM and a RAM which are connected to each other via an internal bus; a storage device 104, such as a hard disk device; a display circuit 110; an input device 120 including a keyboard and a mouse; an audio unit 130 having an audio circuit, a microphone and a loudspeaker; an external interface (I/F) 140; and a short distance wireless transceiver 145 which is connected to the external interface 140. The main unit has a display device 112, such as an LCD, which is connected to the display circuit 110.

The mobile telephone 20 includes: a processor 202 having a CPU, a ROM and a RAM which are connected to each other via an internal bus; a storage device 204, such as a ROM and a RAM; a display device 210; a key input device 220; an audio unit 230 having an audio circuit, a microphone and a loudspeaker; an external interface (I/F) 240; a short distance wireless transceiver 245 which is connected to the external interface 240; and a telephone transceiver 250.

The telephone 20 communicates with another telephone or a Web server via the mobile telephone transceiver 250 over a mobile telephone network 40. The PC 10 and the telephone 20 communicate with each other by using the interfaces 140 and 240 which are connected via a cable 50, or on a communication path 52 via the short distance wireless transceivers 145 and 245. Typically, the transceivers 145 and 245 perform communications in accordance with a short distance wireless communication standard, for example, the Bluetooth™ standard or a wireless LAN standard in compliance with to IEEE 802.11.

The Bluetooth standard uses the 2.4 GHz band (2.402 GHz-20480 GHz) called ISM (Industrial, Scientific and Medical) band. It defines three power classes of 100 mW, 2.5 mW and 1 mW. In Power Class 3, short distance communications in a rage of about 10 m can be done. The Bluetooth standard employs the GFSK modulation and the frequency hopping scheme. The wireless LAN standard, such as IEEE 8002.11, uses the 2.4 GHz band (2.40 HHz-2.497 GHz) and employs the spread spectrum scheme and the DBPSK or DQPSK modulation, or the frequency hopping scheme and the GFSK modulation, for communications.

The storage device 104 of the PC 10 stores an operation system (OS) and application programs, such as a mobile telephone application for a PC. The processor 102 operates in accordance with the OS and the application programs. Alternatively, the OS and the application programs may be implemented on the processor 102 in the form of hardware, such as an integrated circuit.

The storage device 204 of the mobile telephone 20 stores an OS, a mobile telephone application, and a control object (control program) for a PC which is used for controlling the mobile telephone, which will be described later. The processor 202 operates in accordance with the OS and application programs. Alternatively, the OS and the application may be implemented on the processor 202 in the form of hardware, such as an integrated circuit.

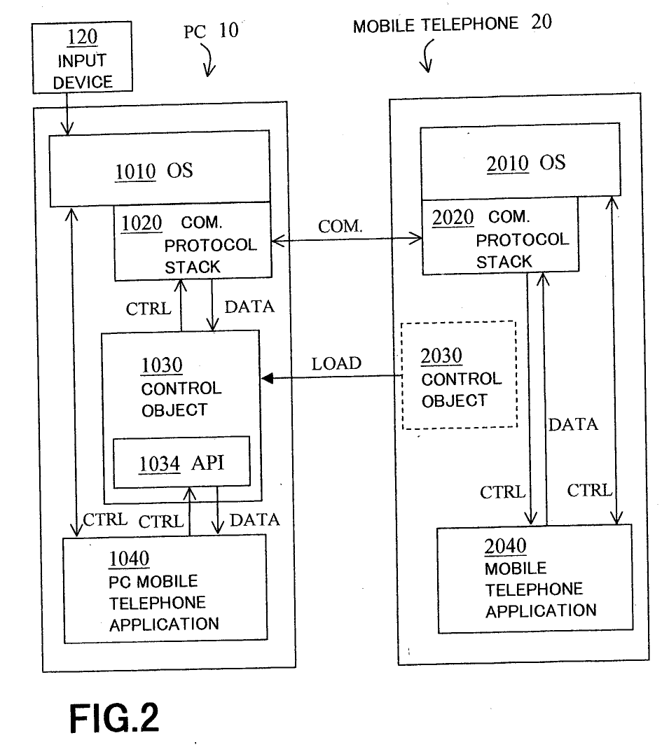

FIG. 2 shows the schematic configurations of functions of the OS's and applications which are related to the invention, and which are implemented on the processor 102 of the PC 10 and on the processor 202 of the mobile telephone 20, respectively. In the mobile telephone 20, the processor 202 operates in accordance with the OS 2010, a communication protocol stack 2020, and the mobile telephone application 2040. The storage device 204 stores the PC control object 2030. The PC 10 receives the control object 2030 from the mobile telephone 20, and stores it as a control object 1030 into the storage device 104. In the PC 10, the processor 102 operates in accordance with the OS 1010, a communication protocol stack 1020, the control object 1030, and a PC mobile telephone application 1040. The control object 1030 includes an API (Application Program Interface) 1034 for interface with the PC mobile telephone application 1040.

In the PC 10, the PC mobile telephone application 1040 controls the control object 1030 via the API 1034. The control object 1030 communicates with the mobile telephone 20 through the communication path 50 or 52 via the communication protocol stack 1020, to control the mobile telephone 20.

In the mobile telephone 20, the mobile telephone application 2040 communicates with the PC 10 on the communication path 50 or 52 via the communication protocol stack 2020, and operates in accordance with control commands from the control object 1030.

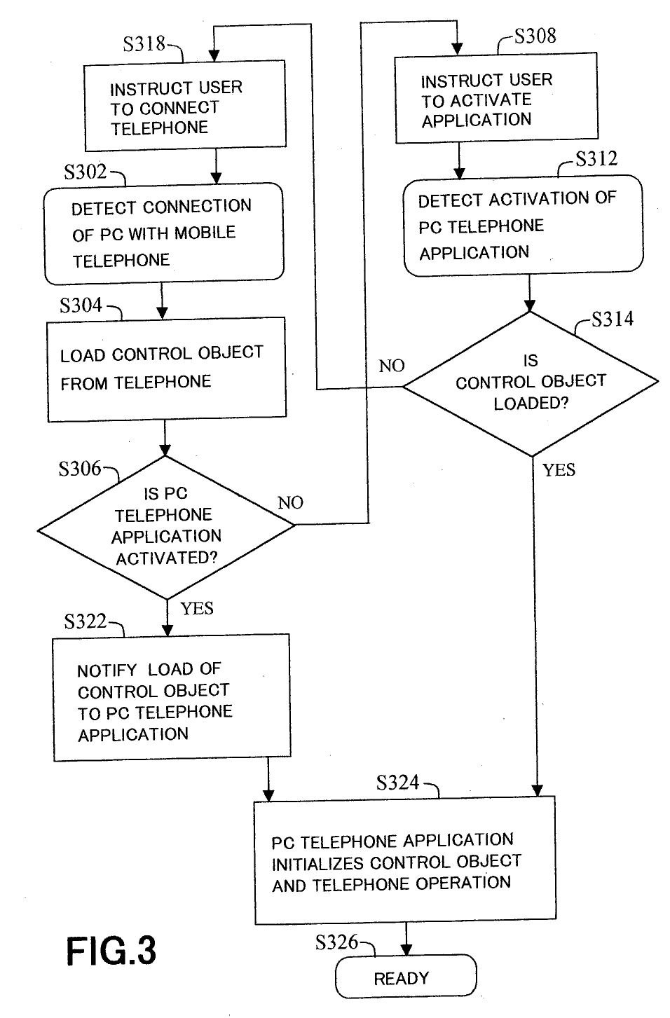

FIG. 3 is a flow diagram for a preliminary process for allowing the mobile telephone 20 to be controlled by operating the PC 10, in accordance with the invention. Referring also to FIGS. 1 and 2, the operation of the PC 10 will be described. The OS 1010 at Step 302 detects when the PC 10 is connected to the mobile telephone 20 by the user, and at Step 312 detects when the PC mobile telephone application 1040 is activated in the PC 10 by the user. When the PC mobile telephone application 1040 is activated, the application 1040 may automatically activate the transceiver 145 to establish a connection with the transceiver 245 of the telephone 20 by short distance wireless communication.

At Step 302, the connection is detected by detecting or determining when the interface 140 of the PC 10 is connected by the user to the interface 240 of the telephone 20 via the cable 50, or by detecting when the user activates the transceiver 145 of the PC 10 to establish the connection with the transceiver 245 of the telephone 20 via short distance wireless communication. When the PC 10 is connected to the telephone 20 in accordance with the IEEE 1394 standard or by a cable via the USB, the connection is notified as a hardware interruption to the OS by means of, for example, the Plug and Play function proposed by Microsoft® Corporation and Intel Corporation. When the PC 10 is connected to the telephone 20 by a cable via an Ethernet® interface, the connection can be detected by a higher layer protocol such as Jini proposed by Sun Microsystems, Inc. or UPnP (Universal Plug and Play) proposed by Microsoft® Corporation.

At Step 304 following Step 302, the OS 1010 requests the telephone 20 to transfer the control object 2030 through the communication path 50 or 52. In response to the request, the OS 2010 of the telephone 20 sends the control object 2030 stored in the storage device 204, to the PC 10 through the communication path 50 or 52. The OS 1010 receives and loads the sent object as the control object 1030 into the storage device 104 and implements the object on the processor 102.

At Step 306, the OS 1010 determines whether the telephone application 1040 is being activated on the PC 10 or not. If it is determined that the application is being activated, the OS 1010 at Step 322 informs the telephone application 1040 that the control object 1030 is loaded into the PC 10. If it is determined that the application is not activated, the procedure proceeds to step 308.

At Step 308, the OS 1010 instructs the user to activate the PC telephone application 1040. In accordance with the instruction, the user activates the telephone application 1040 in the PC 10. Alternatively, the OS 1010 may automatically activate the PC telephone application 1040.

At Step 312, the OS 1010 detects when the mobile telephone application 1040 is activated.

At Step 314, the OS 1010 determines whether the control object is loaded into the PC 10 or not. If it is determined that the control object is loaded, the procedure proceeds to Step 324. If it is determined that the control object is not loaded, the procedure proceeds to Step 318.

At Step 318, the OS 1010 instructs the user to connect the PC 10 to the telephone 20. In accordance with the instruction, the user connects the PC 10 to the telephone 20. Alternatively, the OS 1010 may activate the transceiver 145 to automatically establish a connection with the transceiver 245 of the telephone 20 by short distance wireless communication.

At Step 324, the PC telephone application 1040 initializes the control object 1030, and controls the control object 1030 so as to initialize the operation of the telephone 20. At Step 326, the PC 10 becomes ready for controlling the mobile telephone 20.

In response to the ready state, the PC telephone application 1040 displays, on the display device 112, a display device image 114 and a software key arrangement image 116 of a virtual mobile telephone object which simulate the display device 210 and the key arrangement of the key input device 220, respectively, of the mobile telephone 20. The coordinates and the identification of each item in the display screen of the display device image 114 correspond to those on the display screen of the display device 210. In order to make the view easily perceived, the display device image 114 may be made larger than the display area of the display device 210, the same information may be displayed in a magnified manner, or a larger amount of information may be displayed at a time. In order to make the view easily perceived, moreover, the display device image 114 may display information in a format which is different from that of the display of the display device 210, for example, in a different number of lines or in a different character font and style.

The user operates the PC 10 by using the keyboard and/or the mouse of the input device 120, to control the operations of the images 114 and 116 of the virtual mobile telephone. The software keys of the image 116 may correspond to a ten-key pad and function keys of the PC 10. In response to the operation of the PC 10, the virtual mobile telephone operates in cooperation with the telephone 20. Operations of pointing an item in the display screen in the image 114, and pressing a software key in the image 116 are performed by operating, for example, the mouse or a key of the input device 120. Typing characters into the display screen within the image 114 is performed through the keyboard.

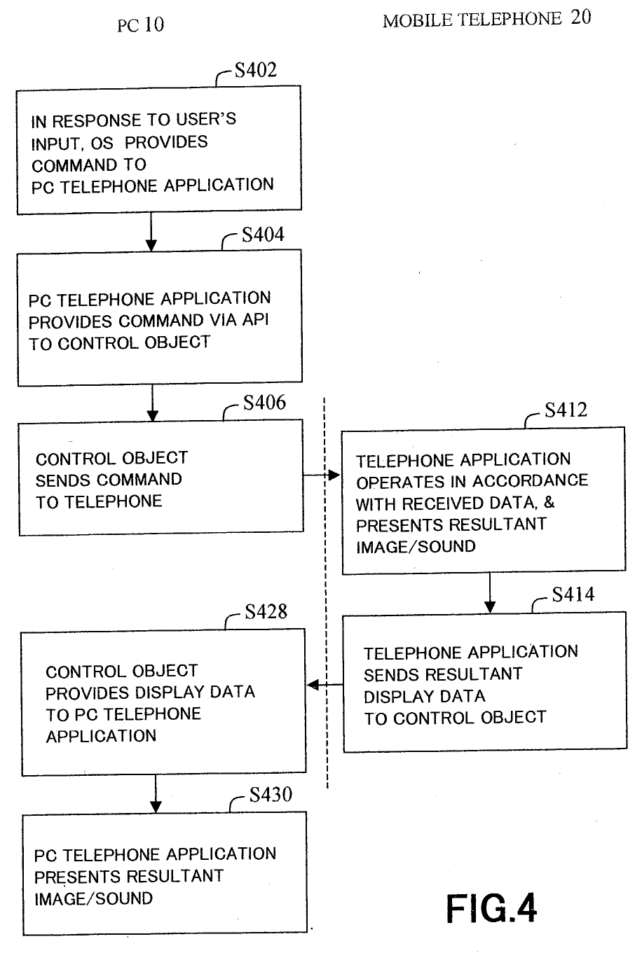

FIG. 4 shows a flow diagram for the operation for controlling the mobile telephone 20 that is executed by the PC 10, in accordance with the invention. At Step 402, while viewing the display device image or screen 114 displayed on the display screen of the display device 112 of the PC 10, the user operates the input device 120 to input a command to operate the telephone 20, and, in response to the input by the user, the OS 1010 supplies a control command to the PC telephone application 1040. Such a command of the user may be a command to access information stored in the storage device 204 of the telephone 20, or a command to access a particular Web page on the telephone network 40 by means of a URL.

At Step 404, the application 1040 operates in accordance with the command from the OS 1010 to change the display content of the display device image 114, if necessary, and supplies the command to the control object 1030 via the API 1034. The command may contain the coordinates or the item identification in the display screen of the display device 210 of the telephone 20. If necessary, the application 1040 converts the coordinates or the item identification in the display screen of the display device image 114, into those in the display screen of the display device 210 of the telephone 20.

At Step 406, in accordance with the command from the application 1040, the control object 1030 sends a command to the telephone 20 through the communication path 50 or 52 via the communication protocol stack 1020.

At Step 412, the telephone application 2040 operates in accordance with the command which is received from the PC 10 via the communication protocol stack 2020, and displays, on the display device 210, an image which is obtained as a result of the operation, and/or presents obtained sound through the audio unit 230. When a command to access a particular Web page by means of a URL is received, the telephone application 2040 connects the telephone to the Web server in the telephone network 40 to capture its Web page, displays the image of the page on the display device 210, and presents associated sound through the audio unit 230.

At Step 414, the telephone application 2040 sends data for displaying a result of the operation to the control object 1030 of the PC 10 via the communication protocol stack 2020. The display data may be representative of the image displayed on the display device 210 of the telephone 20, and/or sound for the audio unit 230, or a state code indicating the operation state of the telephone 20 related to the image and sound to be presented.

At Step 428, the control object 1030 supplies the display data to the telephone application 1040 via the API 1034.

At Step 430, in accordance with the display data supplied from the control object 1030, the telephone application 1040 displays the resultant display image on the display device 112 of the PC 10, and/or presents the resultant sound through the audio unit 130. When the display data is representative of a Web page, the telephone application 1040 displays the image of the page on the display device 110, and presents associated sound through the audio unit 130.

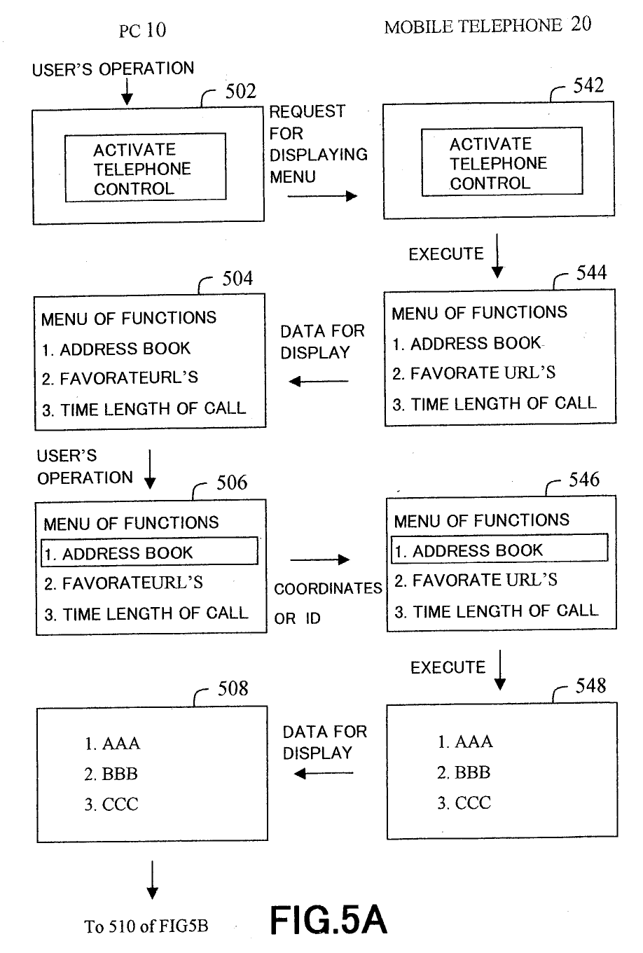

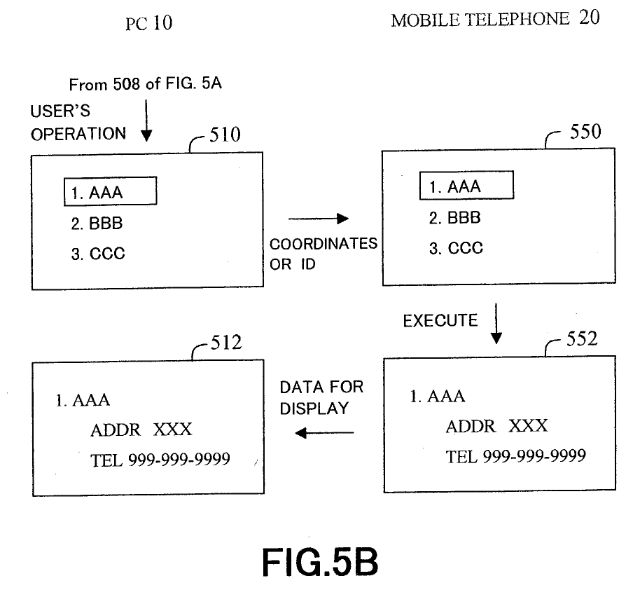

FIGS. 5A and 5B show an example of display screens 502 to 512 on the PC 10, and display screens 542.to 552 on the mobile telephone 20, which are displayed in accordance with the flow diagram of FIG. 4.

The user operates the input device 120 on the PC 10 to cause the telephone application 1040 to display the initial screen 502 on the display screen in the display device image 114 of the display device 112, and to activate the control of the telephone. In response to the activation, the telephone application 1040 sends a command to display “FUNCTION MENU” to the telephone 20 through the communication path 50 or 52. In response to the reception of the command, the telephone application 2040 of the telephone 20 displays the display screen 542 for activating the control of the telephone on the display device 210, and executes the display of “FUNCTION MENU”.

Thereafter, the telephone application 2040 of the telephone 20 displays the display screen 544 of “FUNCTION MENU” on the display device 210, and sends display data representative of the display screen 544 to the PC 10 through the communication path 50 or 52. As described above, the display data may be image data of the screen 544, or an operation state code indicating the current operation state of the telephone 20 or the display of the display screen 544. In response to the reception of the display data, the telephone application 1040 of the PC 10 displays the screen 504 of “FUNCTION MENU” corresponding to the screen 544, in the display screen of the display device image 114. When the telephone application 1040 receives the operation state code, the application fetches corresponding image data stored in the storage device 104, and displays the data in the display screen of the display device image 114 after editing the data, if necessary.

The user again operates the input device 120 of the PC 10 to point and select an item in the display screen 504 of the function menu, “ADDRESS BOOK” for example. The telephone application 1040 then displays the screen 506 in which the item “ADDRESS BOOK” is highlighted, in the display screen of the display device image 114. The telephone application 1040 sends the position coordinates corresponding to the selected item “ADDRESS BOOK” in the display screen 506, or an identification code of the item to the telephone 20 through the communication path 50 or 52 via the control object 1030. In response to the reception of the coordinates or the identification code, the telephone application 2040 of the telephone 20 displays the corresponding display screen 546 in which the item “ADDRESS BOOK” is highlighted, activates the function of the selected item “ADDRESS BOOK”, and retrieves a list of indices from an address book database which is stored in the storage device 204, for example.

Thereafter, the telephone application 2040 of the telephone 20 displays the display screen 548 of “ADDRESS BOOK” on the display device 210, and sends display data representative of the display screen 548 to the PC 10 through the communication path 50 or 52. In response to the reception of the display data via the control object 1030, the telephone application 1040 of the PC 10 displays the corresponding display screen 508 in the display screen of the display device image 114.

The user again operates the input device 120 of the PC 10 to point and select an item such as a name “AAA” in “ADDRESS BOOK”, and the telephone application 1040 then displays the display screen 510 in which the item “AAA” is highlighted, in the display screen of the display device image 114. The telephone application 1040 sends the position coordinates corresponding to the selected item “AAA” in the display screen 510, or an identification code of the item to the telephone 20 through the communication path 50 or 52 via the control object 1030. In response to the reception of the coordinates or the identification code, the telephone application 2040 of the telephone 20 displays the corresponding display screen 550 in which the item “AAA” is highlighted, executes the display of the address information of the selected item “AAA”, and retrieves a index information corresponding to the item from the address book database.

Thereafter, the telephone application 2040 of the telephone 20 displays the display screen 552 of the address information corresponding to the item “AAA” on the display device 210, and sends display data representative of the display screen 552 to the PC 10 through the communication path 50 or 52 via the control object 1030. In response to the display data, the telephone application 1040 of the PC 10 displays the corresponding display screen 512 of the address information in the display screen of the display device image 114.

In a similar manner, the user may operate the PC 10 to easily prepare an electronic mail in the mobile telephone 20, and then send the mail to the telephone network 40. Similarly, the user may operate the PC 10 to easily access a Web page in the telephone network 40 through the mobile telephone 20. It should be understood by those skilled in the art that the invention can be applied also to an enhanced fixed telephone.

The above-described embodiment is only a typical example, and its modifications and variations are apparent to those skilled in the art. It should be noted that people skilled in the art can make various modifications to the above-described embodiment without departing from the principle of the invention and the accompanying claims.

What is claimed is:

1. An information processing apparatus which is connectable to a telephone, wherein
said processing apparatus comprises a processor, a display device, and an input device,
said processor displays information which is to be displayed on said telephone, on said display device, and
in response to operation of said input device by a user, said processor sends a control signal which is adapted to control said telephone.

2. An information processing apparatus according to claim 1, wherein said processor sends an input by the user through said input device, as coordinates in a display of said telephone, to said telephone.

3. An information processing apparatus according to claim 1, wherein said processor sends an input by the user through said input device, as identification of an item in a display of said telephone, to said telephone.

4. An information processing apparatus according to claim 1, wherein, in response to an input by the user through said input device, said processor changes the display of the information on said display device.

5. An information processing apparatus according to claim 1, wherein, in response to reception of data representative of display information from said telephone, said processor displays the display information on said display device.

6. An information processing apparatus according to claim 5, wherein the data representative of the display information is image data.

7. An information processing apparatus according to claim 5, wherein the data representative of the display information is data indicating an operation state of said telephone.

8. An information processing apparatus according to claim 1, wherein said processor operates to pre-load a control object from said telephone, said control object being to be used together with a telephone application which is implemented on said processor.

9. An information processing apparatus according to claim 1, wherein said telephone is a mobile telephone.

10. An information processing apparatus according to claim 1, wherein said information processing apparatus is connectable to said telephone via a cable.

11. An information processing apparatus according to claim 1, wherein said processing apparatus is connectable to said telephone by short distance wireless communication.

12. A telephone which is connectable to an information processing apparatus, wherein
said telephone comprises a processor, a display device, and an input device,
said processor receives a control signal,
in response to the received control signal, said processor operates and displays information on said display device, and
said processor sends back data representative of the information.

13. A telephone according to claim 12, wherein said processor further receives an input into said information processing apparatus, as coordinates in a display of said display device, from said information processing apparatus.

14. A telephone according to claim 12, wherein said processor further receives an input into said information processing apparatus, as identification of an item in a display of said display device, from said information processing apparatus.

15. A telephone according to claim 12, wherein the data representative of the display information is image data.

16. A telephone according to claim 12, wherein the data representative of the display information is data indicating an operation state of said telephone.

17. A telephone according to claim 12, wherein said processor operates to pre-load a control object for controlling said telephone into said information processing apparatus.

18. A telephone according to claim 12, wherein, in response to the control signal from said information processing apparatus, said telephone communicates with another apparatus over a telephone network.

19. A program stored on a storage medium for an information processing apparatus and for controlling a telephone which is connectable to said information processing apparatus, said information processing apparatus comprising a display device and an input device, said program being operable to effect the steps of:
displaying information which is to be displayed on said telephone, on said display device; and
sending a control signal which is adapted to control said telephone, in response to an operation of said input device by a user.

20. A program according to claim 19, wherein said control signal contains coordinates in a display of said telephone.

21. A program according to claim 19, wherein said control signal contains an identification of an item in a display of said telephone.

22. A program according to claim 19, being operable to further effect the step of changing a display of the information on said display device, in response to an input by the user from said input device.

23. A program according to claim 19, being operable to further effect the step of displaying the display information on said display device, in response to reception of data representative of display information from said telephone.

24. A program according to claim 19, being operable to further effect the step of pre-loading, from said telephone a control object, an control object for controlling said telephone.

25. A program stored on a storage medium for an information processing apparatus and for controlling a telephone which is connectable to said information processing apparatus, said information processing apparatus comprising a display device, said program being operable to effect the steps of:
receiving a control signal,
operating in response to the received control signal, and displaying information on said display device, and
sending back data representative of the information.

26. A program according to claim 25, being operable to further effect the step of pre-loading a control object for controlling said telephone into said information processing apparatus.

27. In an information processing apparatus, a method for controlling a telephone which is connectable to said information processing apparatus, said information processing apparatus comprising a display device and an input device, said method comprising the steps of:
displaying information which is to be displayed on said telephone, on said display device; and
sending a control signal which is adapted to control said telephone, in response to an operation of said input device by a user.

28. In an information processing apparatus, a method for controlling a telephone which is connectable to said information processing apparatus, said information processing apparatus comprising a display device, said method comprising the steps of:
receiving a control signal,
operating in response to the received control signal, and displaying information on said display device, and
sending back data representative of the information.
